(19) United States
(12) Patent Application Publication
(10) Pub. No.: US 2012/0294310 A1
(43) Pub. Date: Nov. 22, 2012

(54) Wide Area Network Interface Selection Method and Wide Area Network System Using the Same

(76) Inventors: Chia-Wei Yen, Hsinchu County (TW); Chung-Chi Lo, Hsinchu County (TW); JIAN-LI MAO, Hsinchu County (TW); YINYUN SHEN, Hsinchu County (TW)

(21) Appl. No.: 13/110,889

(22) Filed: May 18, 2011

(51) Int. Cl. H04L 12/56

(52) U.S. Cl. 370/392

(57) ABSTRACT

The present invention discloses a wide area network (WAN) interface selection method for a WAN system comprising a plurality of WAN interfaces. The WAN interface selection method includes steps of receiving a plurality of packets from a local area network (LAN) side; selecting respective WAN interfaces from the plurality of WAN interfaces for the plurality of packets according to network address translation (NAT) session information of the plurality of packets; and sending out the plurality of packets through the respective WAN interfaces.

### BACKGROUND OF THE INVENTION

1. Field of the Invention

The present invention relates to a wide area network (WAN) interface selection method and WAN system using the same, and more particularly, to a wide area network (WAN) interface selection method and WAN system using the same capable of selecting WAN interfaces for packets according to network address translation (NAT) session information of the packets, so as to achieve better load sharing between WAN interfaces.

2. Description of the Prior Art

A dual wide area network (WAN) system includes a router and two WAN interfaces on two digital subscriber line (DSL) lines. Under such a configuration, the router can receive packets from a local area network (LAN) side and send out the packets to a WAN side through the two WAN interfaces on the DSL lines.

Therefore, in order to achieve better load sharing between the two WAN interfaces for maximizing efficiency, a processor is utilized to determine which WAN interface should a packet be sent out through. Conventionally, the processor makes the decision according to a source internet protocol (IP) address or asynchronous transfer mode (ATM) bonding of the packet.

However, in the case where the processor makes the decision according to the source IP address of the packet, when only one source IP address from the LAN side sends out packets to the WAN side, only one WAN interface would be utilized for sending out all these packets. This cannot achieve a true bandwidth aggregation, i.e. load sharing between the two WAN interfaces. On the other hand, in the case where the processor makes the decision according to ATM bonding of the packet, load sharing between the two WAN interfaces can not be achieved simply by software implementation since ATM bonding would require additional hardware implementation. It will increase the cost.

Thus, there is a need for improvement of those conventional systems.

### SUMMARY OF THE INVENTION

It is therefore an objective of the present invention to provide a wide area network (WAN) interface selection method and WAN system using the same capable of selecting WAN interfaces for packets according to network address translation (NAT) session information of the packets, so as to achieve better load sharing between WAN interfaces.

The present invention discloses a wide area network (WAN) interface selection method for a WAN system comprising a plurality of WAN interfaces. The WAN interface selection method includes steps of receiving a plurality of packets from a local area network (LAN) side; selecting respective WAN interfaces from the plurality of WAN interfaces for the plurality of packets according to network address translation (NAT) session information of the plurality of packets; and sending out the plurality of packets through the respective WAN interfaces.

The present invention further discloses a wide area network (WAN) system capable of performing load sharing. The WAN system includes a plurality of WAN interfaces; and a processor, for receiving a plurality of packets from a local area network (LAN) side, and selecting respective WAN interfaces from the plurality of WAN interfaces for the plurality of packets according to network address translation (NAT) session information of the plurality of packets, to send out the plurality of packets through the respective WAN interfaces.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wide area network (WAN) system according to an embodiment of the present invention.

FIG. 2 is a schematic diagram of operations of the WAN system shown in FIG. 1 receiving packets from a local area network (LAN) side to forward to a WAN side according to an embodiment of the present invention.

FIG. 3 is a schematic diagram of a round robin selection process according to an embodiment of the present invention.

FIG. 4 is a schematic diagram of a hash selection process according to an embodiment of the present invention.

FIG. 5 is a schematic diagram of operations of the WAN system shown in FIG. 1 receiving packets from a WAN side to forward to a LAN side according to an embodiment of the present invention.

FIG. 6 is a schematic diagram of a selection process according to an embodiment of the present invention.

### DETAILED DESCRIPTION

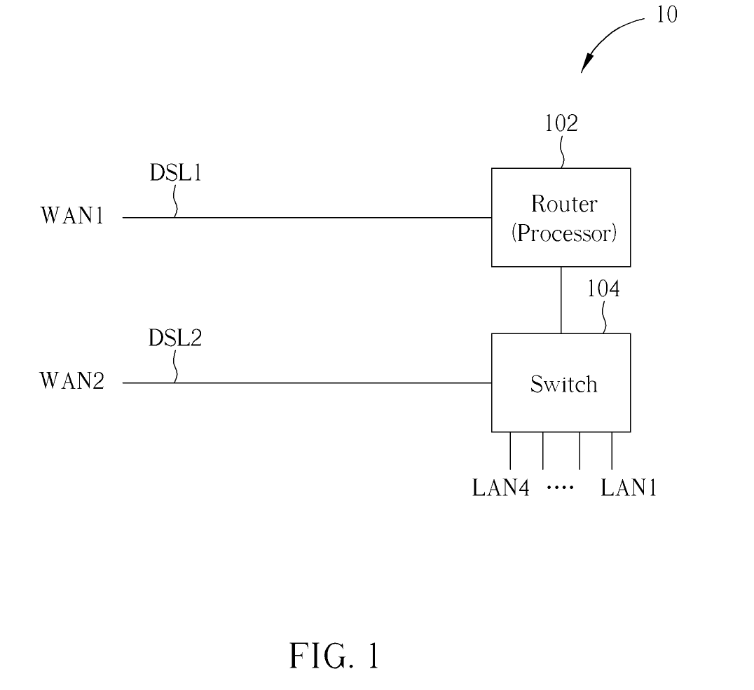

Please refer to FIG. 1, which is a schematic diagram of a wide area network (WAN) system 10 according to an embodiment of the present invention. The WAN system 10 includes two WAN interfaces WAN1, WAN2 on two digital subscriber line (DSL) lines DSL1, DSL2, a router 102, a switch 104, and local area network (LAN) interfaces LAN1-LAN4. The switch 104 receives packets from a LAN side through the LAN interfaces LAN1-LAN4, and forwards the packets to the router 102. The router 102 includes a processor for selecting respective WAN interfaces from the WAN interfaces WAN1, WAN2 for the packet transmission according to network address translation (NAT) session information of the packets. In such a system, even all packets are sent out from only one source IP address of the LAN side to different destinations of the WAN side, the two WAN interfaces can be used for sending out all these packets alternatively since packets for different destinations can be corresponding to different NAT sessions. As a result, the WAN system 10 can achieve a better bandwidth aggregation, i.e. efficient load sharing between WAN interfaces, by software implementation of the processor without other additional hardware devices.

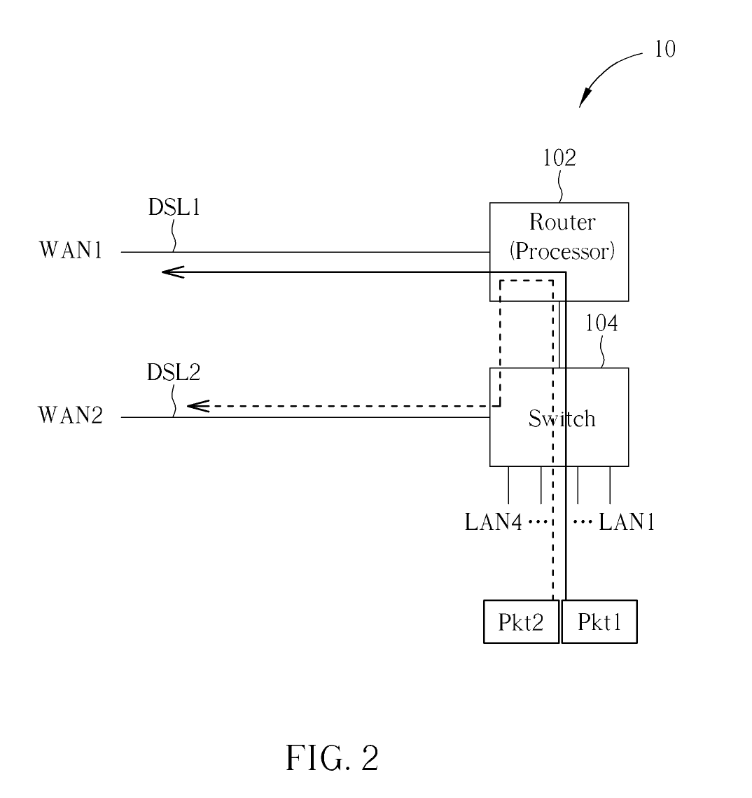

Specifically, please refer to FIG. 2, which is a schematic diagram of operations of the WAN system 10 receiving packets Pkt1, Pkt2 from the LAN side to the WAN side according to an embodiment of the present invention. The switch 104 receives packets Pkt1, Pkt2 from the LAN side through the LAN interfaces LAN2, LAN3, and forwards the packets Pkt1, Pkt2 to the router 102.

In this embodiment, if the packet Pkt1 is corresponding to a NAT session of a NAT session table stored in the processor, the processor selects a respective WAN interface specified in the NAT session for the packet Pkt1, and then sends out the packet Pkt1 to the WAN side through the respective WAN interface, e.g. the WAN interface WAN1.

On the other hand, in another embodiment, if the packets Pkt1, Pkt2 are not corresponding to any NAT session of the NAT session table stored in the processor, the processor selects respective WAN interfaces from the WAN interfaces WAN1, WAN2 sequentially for the packets Pkt1, Pkt2 by a round robin method, e.g. selects the WAN interface WAN1 as the respective WAN interface for the packets Pkt1 and selects the WAN interface WAN2 as the respective WAN interface for the packets Pkt2. Then, the processor uses the respective WAN interfaces to create NAT sessions of the packets Pkt1, Pkt2 and store related information in the NAT session table, and then sends out the packets Pkt1, Pkt2 to the WAN side through the respective WAN interfaces.

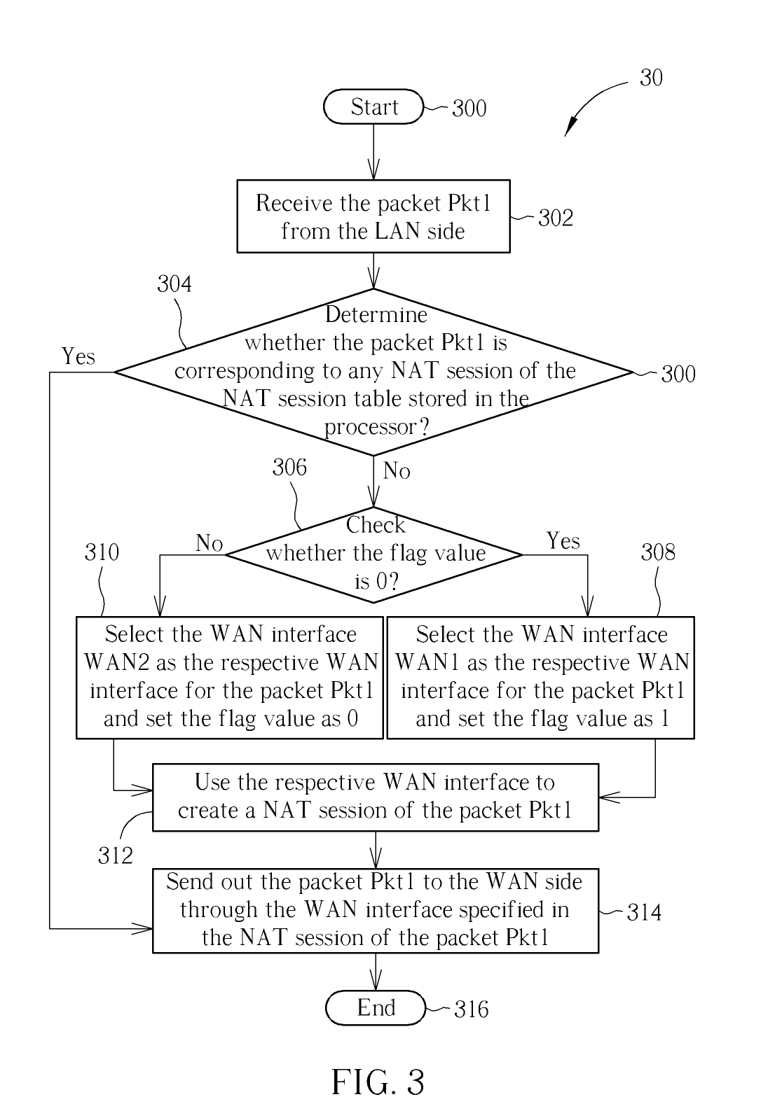

For example, please refer to FIG. 3, which is a schematic diagram of a round robin selection process 30 according to an embodiment of the present invention, wherein a flag value is utilized for alternating between the WAN interfaces WAN1, WAN2. The round robin selection process 30 includes the following steps:

Step 300: Start.

Step 302: Receive the packet Pkt1 from the LAN side.

Step 304: Determine whether the packet Pkt1 is corresponding to any NAT session of the NAT session table stored in the processor. If yes, go to step 314; otherwise, go to step 306.

Step 306: Check whether the flag value is 0. If yes, go to 308; otherwise, go to step 310.

Step 308: Select the WAN interface WAN1 as the respective WAN interface for the packet Pkt1 and set the flag value as 1. Go to step 312.

Step 310: Select the WAN interface WAN2 as the respective WAN interface for the packet Pkt1 and set the flag value as 0. Go to step 312.

Step 312: Use the respective WAN interface to create a NAT session of the packet Pkt1.

Step 314: Send out the packet Pkt1 to the WAN side through the WAN interface specified in the NAT session of the packet Pkt1.

Step 316: End.

Noticeably, in this embodiment, the packets Pkt1, Pkt2 are received from different source IP addresses and thus corresponding to different NAT sessions, such that the packets Pkt1, Pkt2 can be sent out through different respective WAN interfaces. Even when the packets Pkt1, Pkt2 are received from the same source IP address but different NAT sessions, e.g. different destinations, such that the packets Pkt1, Pkt2 can still be sent out through different respective WAN interfaces.

In another embodiment, if the packet Pkt1 is not corresponding to any NAT session of the NAT session table stored in the processor, the processor selects a respective WAN interface from the WAN interfaces WAN1, WAN2 for the packet Pkt1 by a hash algorithm according to NAT session information, such as a source IP address, a destination address and a protocol number, of the packet Pkt1. Then, the processor uses the respective WAN interface to create a NAT session of the packet Pkt1 and store related information in the NAT session table, and then sends out the packet Pkt1 to the WAN side through the respective WAN interface, e.g. the WAN interface WAN1.

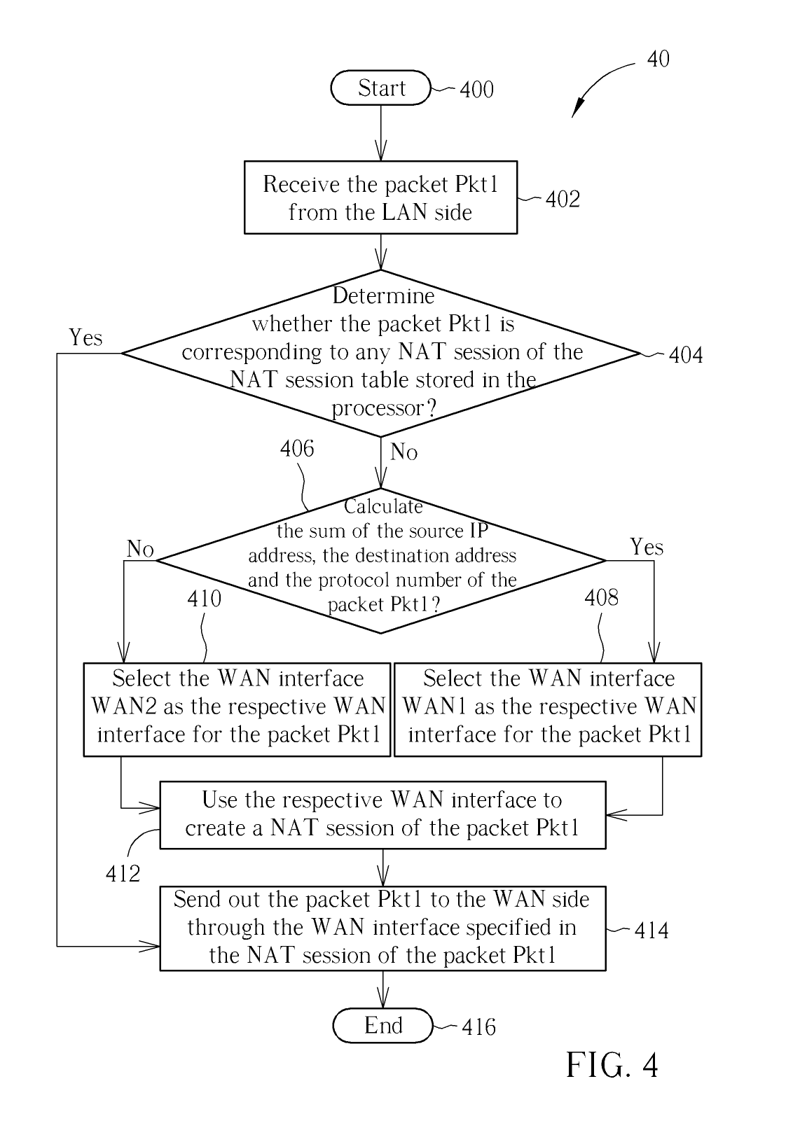

For example, please refer to FIG. 4, which is a schematic diagram of a hash selection process 40 according to an embodiment of the present invention, wherein if the source IP address=x1.x2.x3.x4, the destination address=y1.y2.y3.y4 and the protocol number=z, a sum of the source IP address, the destination address and the protocol number is x+x2+x3+x4+y1+y2+y3+y4+z. The hash selection process 40 includes the following steps:

Step 400: Start.

Step 402: Receive the packet Pkt1 from the LAN side.

Step 404: Determine whether the packet Pkt1 is corresponding to any NAT session of the NAT session table stored in the processor. If yes, go to step 414; otherwise, go to step 406.

Step 406: Calculate the sum of the source IP address, the destination address and the protocol number of the packet Pkt1. If the sum modulo 2 is 0, go to 408; otherwise, go to step 410.

Step 408: Select the WAN interface WAN1 as the respective WAN interface for the packet Pkt1. Go to step 412.

Step 410: Select the WAN interface WAN2 as the respective WAN interface for the packet Pkt1. Go to step 412.

Step 412: Use the respective WAN interface to create a NAT session of the packet Pkt1.

Step 414: Send out the packet Pkt1 to the WAN side through the WAN interface specified in the NAT session of the packet Pkt1.

Step 416: End.

Noticeably, the spirit of the present invention is to select respective WAN interfaces for packets according to NAT session information of the packets, and then send out the packets to a WAN side through the respective WAN interfaces, so as to achieve a better bandwidth aggregation by software implementation of the processor. Those skilled in the art should make modifications or alterations accordingly. For example, number of WAN interfaces of the WAN system 10 is preferably two, i.e. a dual WAN system, but is not limited to this. Besides, the hash selection process 40 utilizes the sum of all of the source IP address, the destination address and the protocol number of the packet Pkt1 to select the respective WAN interface for the packet Pkt1, but the hash selection process 40 can also be achieved by utilizing a sum of only the source IP address and the destination address of the packet Pkt1, i.e. less load sharing.

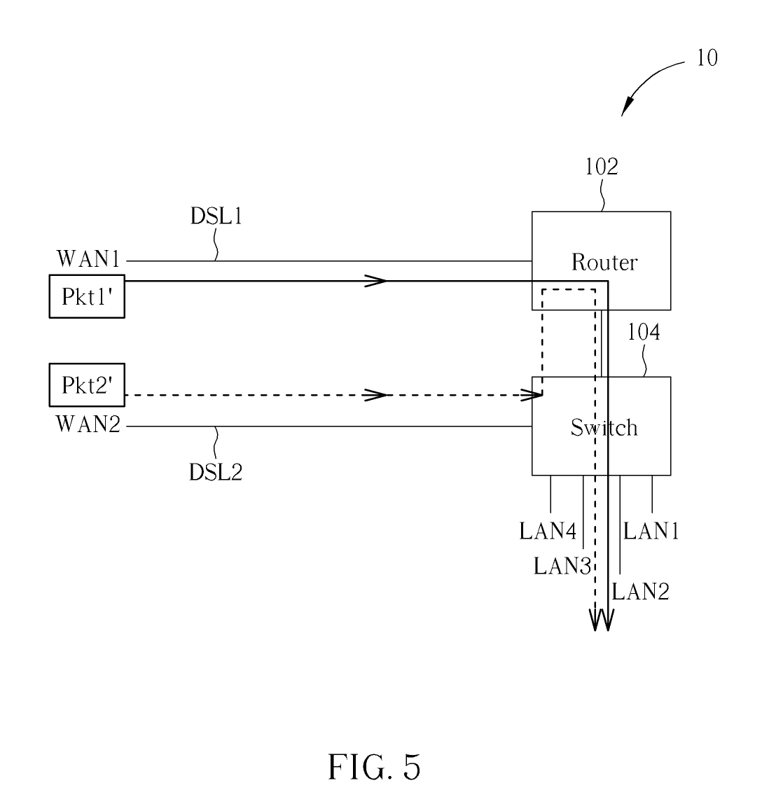

Moreover, please refer to FIG. 5, which is a schematic diagram of operations of the WAN system 10 receiving packets Pkt1′, Pkt2′ from the WAN side to the LAN side according to an embodiment of the present invention. When receiving the packets Pkt1′, Pkt2′ from the WAN side through the WAN interfaces WAN1, WAN2, the processor of the router 102 can look up the NAT session table stored in the processor and send out the packets Pkt1′, Pkt2′ through LAN interfaces, e.g. LAN2, LAN3, specified in NAT sessions of the NAT session table corresponding to the packets Pkt1′, Pkt2′.

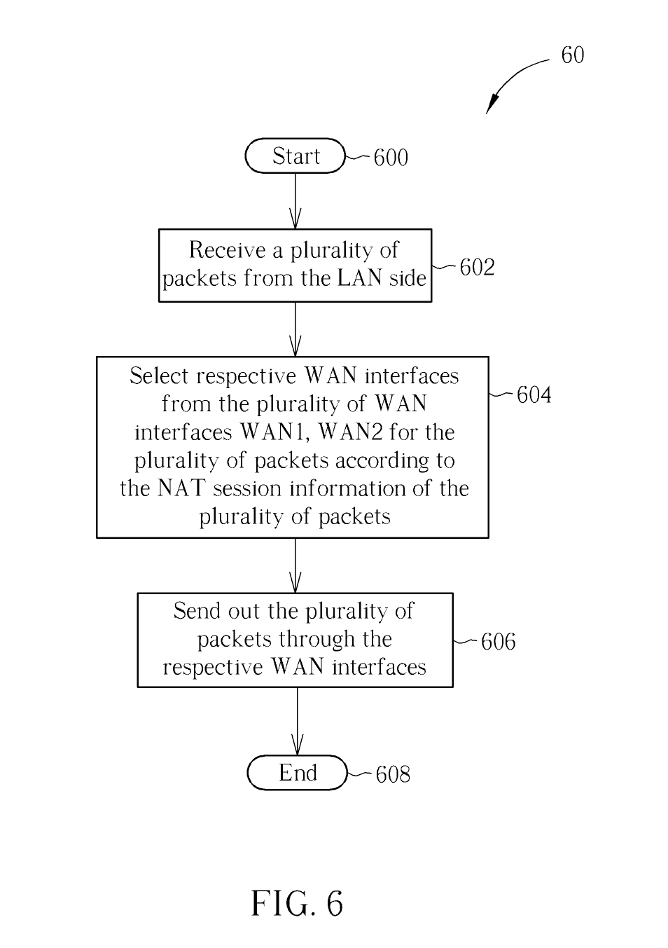

The above operations of the WAN system 10 receiving packets from the LAN side to the WAN side can be summarized into a selection process 60 as shown in FIG. 6. The selection process 60 includes the following steps:

Step 600: Start.

Step 602: Receive a plurality of packets from the LAN.

Step 604: Select respective WAN interfaces from the plurality of WAN interfaces WAN1, WAN2 for the plurality of packets according to the NAT session information of the plurality of packets.

Step 606: Send out the plurality of packets through the respective WAN interfaces.

Step 608: End.

Details of the selection process 60 can be derived by referring to the above corresponding descriptions, and are noted narrated hereinafter.

In conventional systems, if the processor determines which WAN interface should the packet be sent out through according to a source IP address of the packet, it can not achieve a true bandwidth aggregation, i.e. load sharing between the two WAN interfaces; and if the processor determines which WAN interface should the packet be sent out through according to ATM bonding of the packet, additional hardware implementation of ATM bonding is required. In comparison, the present invention selects respective WAN interfaces for packets according to NAT session information of the packets, and then sends out the packets to a WAN side through the respective WAN interfaces. It achieves a better bandwidth aggregation by software implementation of the processor, without additional hardware implementation.

Those skilled in the art will readily observe that numerous modifications and alterations of the device and method may be made while retaining the teachings of the invention.

What is claimed is:

1. A wide area network (WAN) interface selection method for a WAN system comprising a plurality of WAN interfaces, the WAN interface selection method comprising:
receiving a plurality of packets from a local area network (LAN) side;
selecting respective WAN interfaces from the plurality of WAN interfaces for the plurality of packets according to network address translation (NAT) session information of the plurality of packets; and
sending out the plurality of packets through the respective WAN interfaces.

2. The WAN interface selection method of claim 1, wherein the step of selecting the respective WAN interfaces from the plurality of WAN interfaces for the plurality of packets according to the NAT session information of the plurality of packets comprises:
selecting a first respective WAN interface specified in a first NAT session of a NAT session table for a first packet if the first packet is corresponding to the first NAT session.

3. The WAN interface selection method of claim 1, wherein the step of selecting the respective WAN interfaces from the plurality of WAN interfaces for the plurality of packets according to the NAT session information of the plurality of packets comprises:
selecting a plurality of second respective WAN interfaces from the plurality of WAN interfaces sequentially for the plurality of second packets if the plurality of second packets are not corresponding to any NAT session of a NAT session table.

4. The WAN interface selection method of claim 1, wherein the step of selecting the respective WAN interfaces from the plurality of WAN interfaces for the plurality of packets according to the NAT session information of the plurality of packets comprises:
selecting a third respective WAN interface from the plurality of WAN interfaces for a third packet by a hash algorithm according to a third NAT session information of the third packet if the third packet is not corresponding to any NAT session of a NAT session table.

5. The WAN interface selection method of claim 4, wherein the step of selecting the third respective WAN interface from the plurality of WAN interfaces for the third packet by the hash algorithm according to the third NAT session information of the third packet comprises:
selecting the third respective WAN interface from the plurality of WAN interfaces for the third packet by the hash algorithm according to the source IP address, destination address and protocol number of the third packet.

6. A wide area network (WAN) system capable of performing load sharing, comprising:
a plurality of WAN interfaces; and
a processor, for receiving a plurality of packets from a local area network (LAN) side, and selecting respective WAN interfaces from the plurality of WAN interfaces for the plurality of packets according to network address translation (NAT) session information of the plurality of packets, to send out the plurality of packets through the respective WAN interfaces.

7. The WAN system of claim 6, wherein the processor selects a first respective WAN interface specified in a first NAT session of a NAT session table for a first packet if the first packet is corresponding to the first NAT session.

8. The WAN system of claim 6, wherein the processor selects a plurality of second respective WAN interfaces from the plurality of WAN interfaces sequentially for the plurality of second packets if the plurality of second packets are not corresponding to any NAT session of a NAT session table.

9. The WAN system of claim 6, wherein the processor selects a third respective WAN interface from the plurality of WAN interfaces for a third packet by a hash algorithm according to a third NAT session information of the third packet if the third packet is not corresponding to any NAT session of a NAT session table.

10. The WAN system of claim 9, wherein the processor selects the third respective WAN interface from the plurality of WAN interfaces for the third packet by the hash algorithm according to the source IP address, destination address and protocol number of the third packet.
